(19) United States
(12) Patent Application Publication
(10) Pub. No.: US 2014/0132539 A1
(43) Pub. Date: May 15, 2014

(54) TOUCH DISPLAY DEVICE AND OPERATION METHOD OF TOUCH DISPLAY DEVICE

(71) Applicants: Wen-Hsiao Huang, Penghu County (TW); Chien-Ming Lee, Taichung City (TW); Ming-Hsi Chiang, Taichung City (TW); Tso-Wei Liao, Taichung City (TW)

(72) Inventors: Wen-Hsiao Huang, Penghu County (TW); Chien-Ming Lee, Taichung City (TW); Ming-Hsi Chiang, Taichung City (TW); Tso-Wei Liao, Taichung City (TW)

(73) Assignee: WINTEK CORPORATION, Taichung City (TW)

(21) Appl. No.: 14/077,157

(22) Filed: Nov. 11, 2013

(30) Foreign Application Priority Data
Nov. 13, 2012 (TW) 101142248

(51) Int. Cl. G06F 3/041; G06F 1/16

(52) U.S. Cl. CPC G06F 3/041; G06F 1/1692
USPC 345/173; 349/12

(57) ABSTRACT

A touch display device including a light providing unit and a touch panel is provided. The touch panel includes a cover plate, a touch sensing element, and a decoration layer. The cover plate has a light transmission region and a periphery region surrounding the light transmission region. The touch sensing element is disposed in the light transmission region. The decoration layer is disposed in the periphery region. The decoration layer has at least one button opening to define a button touch region located in the periphery region. The light providing unit is at least disposed at a side of the touch panel that faces toward the button opening to provide at least one of a first light and a second light to the button opening, and colors of the first light and the second light are different.

### CROSS-REFERENCE TO RELATED APPLICATION

This application claims the priority benefit of Taiwan application serial no. 101142248, filed on Nov. 13, 2012. The entirety of the above-mentioned patent application is hereby incorporated by reference herein and made a part of this specification.

### BACKGROUND OF THE INVENTION

1. Field of the Invention

The invention relates to a touch display device and particularly relates to a touch display device having an independent button touch region and an operation method thereof.

2. Description of Related Art

Generally speaking, a touch display device includes a display panel and a touch panel for respectively providing the functions of displaying images and sensing touch. In order to provide a quick input function as a hot key, the touch display device may include at least one fixed button in the periphery region around the light transmission region. The touch display device may light up the region of the button for the user to easily see the button in the periphery region. However, according to the current design, only one color is displayed when the button is lighted up regardless of the state of the touch display device. As a result, the user cannot determine if the button in the periphery region has been touched or not. Especially when there are several buttons in the periphery region, the buttons are lighted up at the same time and display the same color, and thus the user cannot judge which of the buttons has been touched.

In addition, for protection of personal data, the user often locks the touch display device. Most of the current designs are to display a specific pattern in the light transmission region for the user to touch along, so as to unlock the touch display device. Such an unlocking method lacks variety and cannot satisfy the user's demand.

### SUMMARY OF THE INVENTION

The invention provides a touch display device which includes an independent button touch region capable of displaying lights of different colors, such that the touch display device provides various operation modes.

The invention provides a touch display device which includes a light providing unit and a touch panel. The touch panel includes a cover plate, a touch sensing element, and a decoration layer. The cover plate has a light transmission region and a periphery region surrounding the light transmission region. The touch sensing element is disposed in the light transmission region. The decoration layer is disposed in the periphery region. The decoration layer has at least one button opening to define a button touch region located in the periphery region. The light providing unit is at least disposed at a side of the touch panel, which faces toward the button opening, to provide at least one of a first light and a second light to the button opening, and colors of the first light and the second light are different from each other.

The invention further provides an operation method of a touch display device. A touch display device, as described above, is provided. A light providing unit is enabled to provide a first light to a button opening when the touch display device is in a locked state. The light providing unit is enabled to provide a second light to the button touch region when the button touch region is touched. Then, it is determined whether the second light is a selected color. If so, unlocking is performed; if not, the touch display device remains in the locked state.

Based on the above, in the invention, the touch panel includes a fixed button located outside the light transmission region. Moreover, the touch display device includes the light providing unit for providing lights of different colors to the button touch region, such that the button displays different colors. Accordingly, the independent button not only serves as a hot key for operations but also provides other functions, e.g. unlocking. In addition, the button touch region displays different colors for the user to recognize whether the button touch region has been touched and provides various visual effects.

To make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic top view of a touch display device according to the first embodiment of the invention.

FIG. 2 is a schematic cross-sectional view illustrating an embodiment of the touch display device of FIG. 1 along the line I-I′.

FIG. 3 is a schematic cross-sectional view illustrating an embodiment of the touch display device of FIG. 1 along the line I-I′.

FIG. 4 is a schematic cross-sectional view illustrating an embodiment of the touch display device of FIG. 1 along the line I-I′.

FIG. 5 is a schematic cross-sectional view illustrating an embodiment of the touch display device of FIG. 1 along the line I-I′.

FIGS. 6A and 6B illustrate an operation of a touch display device according to an embodiment of the invention.

FIG. 7 is a flowchart illustrating an operation of a touch display device according to an embodiment of the invention.

FIGS. 8A to 8C illustrate an operation of a touch display device according to another embodiment of the invention.

FIGS. 9A to 9D are schematic cross-sectional views illustrating several embodiments of a touch panel of the touch display device of FIG. 1A along the line II-II′.

### DESCRIPTION OF THE EMBODIMENTS

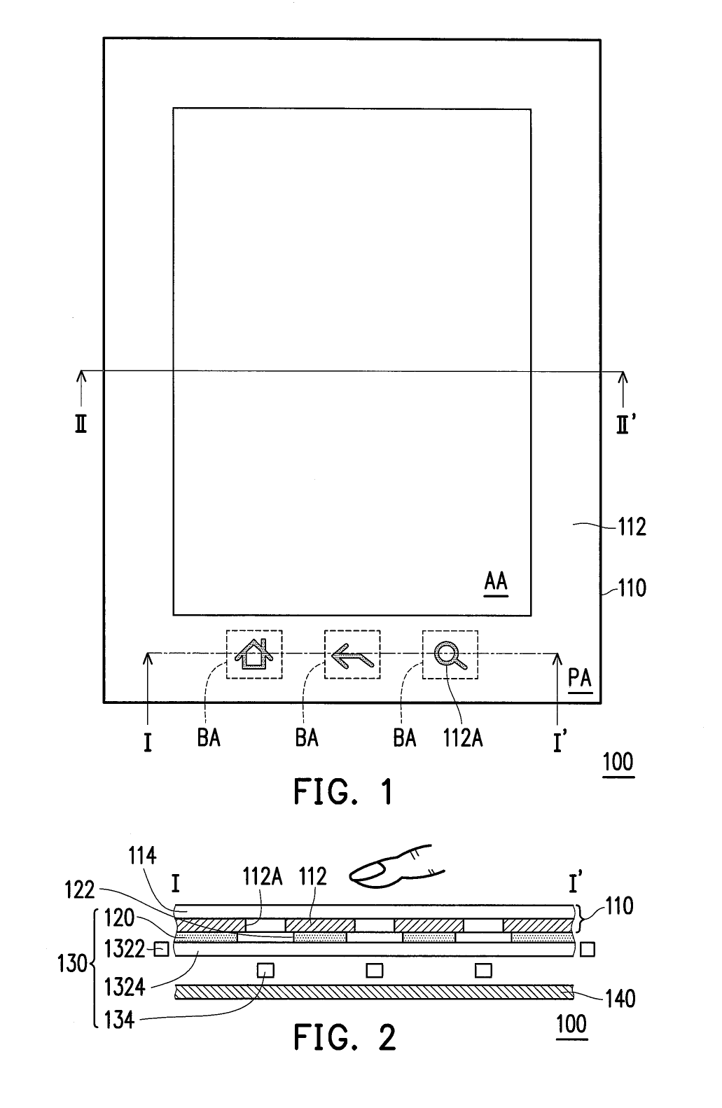

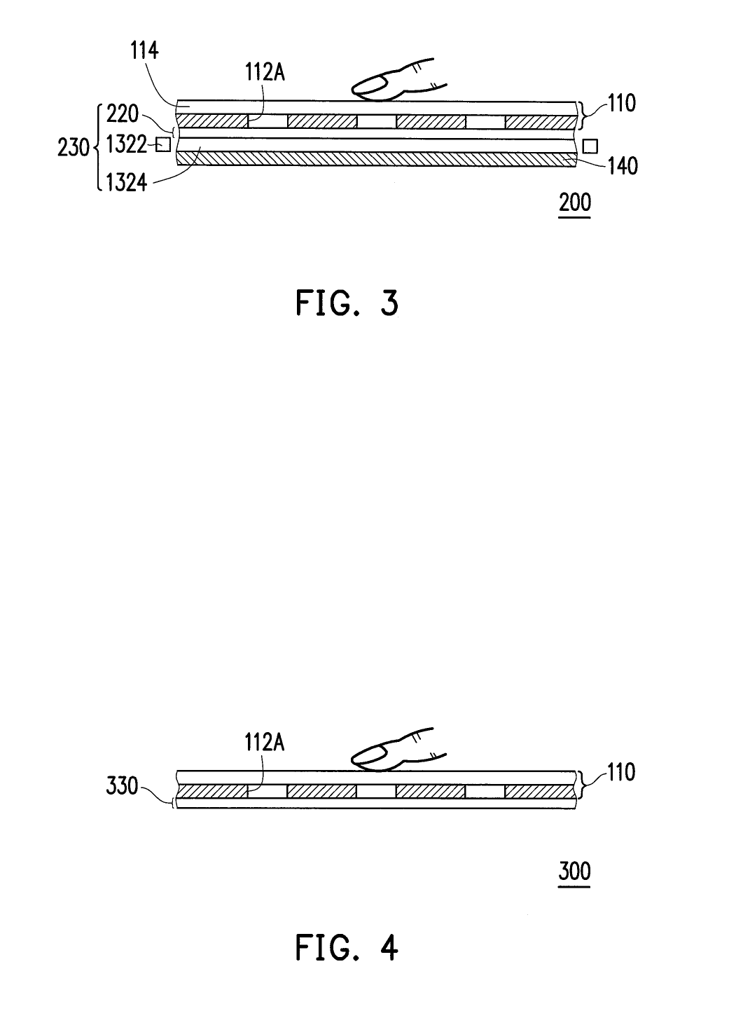

Referring to FIG. 1 and FIG. 2 at the same time, a touch display device 100 includes a touch panel 110 and a light providing unit 130 that are sequentially stacked.

The touch panel 110 includes a cover plate 114 and a decoration layer 112 disposed at a periphery of the cover plate 114. A touch sensing element (not shown) is disposed on the cover plate 114. The decoration layer 112 of the touch panel 110 defines a light transmission region AA, and a periphery region PA is formed at a position of the decoration layer 112. At least one button opening 112A having a button pattern is disposed at the position of the decoration layer 112 and may be filled with a light transmission layer (not shown). The material of the light transmission layer includes at least one of photo resist, colored ink and resin. For example, the number of the button opening 112A is three and the three button openings 112A have three different button patterns shown in FIG. 2. Moreover, a button touch region BA is defined as the region the button opening 112A is located therein. A material of the cover plate 114 may be plastic or a glass material. In addition, the cover plate 114 may be a flexible substrate or a rigid substrate. A material of the decoration layer 112 may be a printing ink material, a photo-resist material, or a ceramic material, etc. In addition, the touch sensing element (not shown) disposed on the cover plate 114 may be formed of sensing electrodes, which are arranged to intersect each other in different directions, or a single-layer conductive electrode, wherein the sensing electrodes are not necessarily disposed on the same plane.

The light providing unit 130 at least includes at least one first light emitting element 1322, a light guide plate 1324, and at least one second light emitting element 134. The light guide plate 1324 is adhered to the decoration layer 112 through an adhesive layer 120. The first light emitting element 1322 is disposed at a side of the light guide plate 1324. A hole 122 is formed in the adhesive layer 120 corresponding to the button opening 112A. The second light emitting element 134 is disposed at a side of the light guide plate 120, which is opposite to the touch panel 110, and is corresponding to the hole 122. Moreover, a reflective plate 140 is disposed under the second light emitting element 134.

The first light emitting element 1322 and the second light emitting element 134 may be light emitting diodes, and the number thereof may be one or more. In addition, the first light emitting element 1322 may be a white light emitting diode, for example, for providing the light required.

As a whole, in this embodiment, the first light emitting element 1322 and the second light emitting element 134 emit lights of different colors. Therefore, by turning on or turning off the first light emitting element 1322 and the second light emitting element 134, the button opening 112A of the touch display device 100 shows at least two colors. In addition, more operation modes are provided if the colors shown by the button opening 112A vary according to different touch actions.

For example, when the button touch region BA is not touched, the first light emitting element 1322 of the light providing unit 130 is turned on and the second light emitting element 134 is turned off. At the same time, light is transmitted from the first light emitting element 1322 to each button opening 112A via the light guide plate 1324 for each button opening 112A to show a white light. When the button touch region BA is touched, the first light emitting element 1322 of the light providing unit 130 is turned off and the second light emitting element 134 is turned on. At the same time, the second light emitting element 134 emits light to the button opening 112A via the hole 122 and the light guide plate 120, so as to provide a colored light which is not white. The button openings 112A at positions that are not touched are in a dark state, for the user to clearly determine whether the button touch region BA has been touched.

In this embodiment, at least three button touch regions BA are disposed in the periphery region PA, and the button openings 112A in the button touch regions BA have different patterns. The different patterns may be used to indicate hot keys of different functions for the user to perform operations more easily. However, it is noted that the number of the button touch regions BA and the patterns disclosed in this embodiment are not intended to limit the scope of the invention.

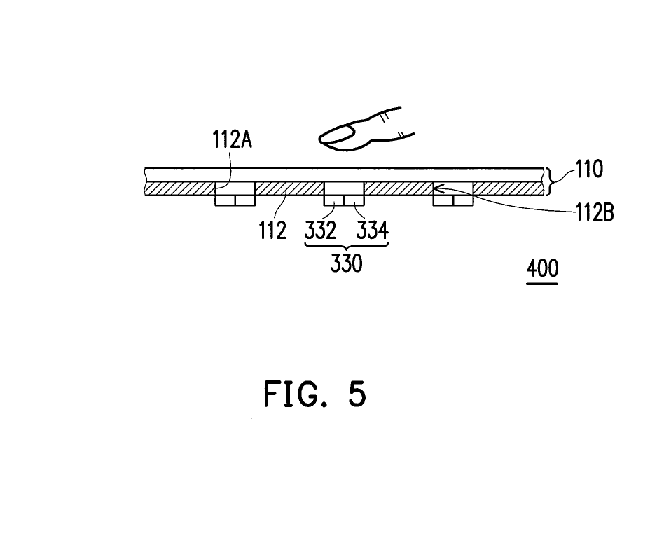

Referring to FIG. 1 and FIG. 3 at the same time, a touch display device 200 is similar to the touch display device 100 and includes a touch panel 110 and a light providing unit 230. The light providing unit 230 is disposed under the touch panel 110, and a color light valve 220, a light guide plate 1324, and a reflective plate 140 are sequentially arranged downward under the touch panel 110. Moreover, at least one first light emitting element 1322 is disposed at a side of the light guide plate 1324.

In this embodiment, the color light valve 220 has a switch function for switching the light provided by the first light emitting element 1322 to different colors. Therefore, by the switching of the switchable color light valve 220, the touch display device 200 displays patterns of different colors in the button touch regions BA, thereby achieving various visual effects.

It is worth mentioning that the switchable color light valve 220 may be a display panel, wherein the display panel may be a portion of the display panel of the light transmission region AA that extends to the periphery region PA or an additional display panel independent from the display panel located at the light transmission region AA. The touch display device 200 may adjust the button openings 112A to display different colors through pixels that display different colors.

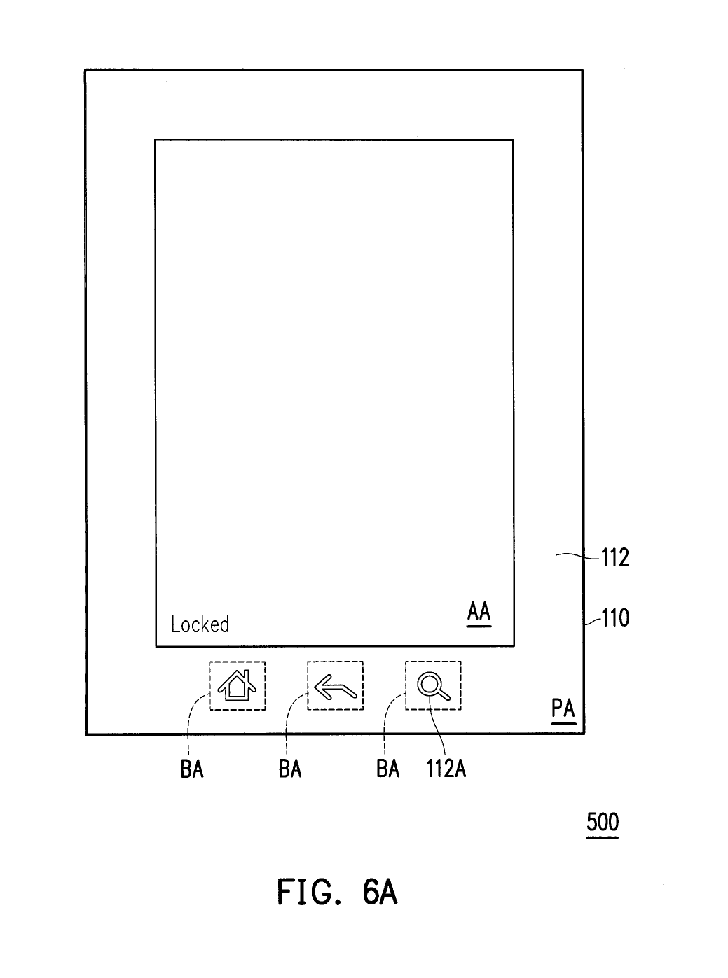

Referring to FIG. 1 and FIG. 4 at the same time, a touch display device 300 includes a touch panel 110 and a light providing unit 330. The light providing unit 330 is a self-luminous display panel, such as an organic light emitting display (OLED), which may be a portion of the display panel of the light transmission region AA that extends to the periphery region PA or an additional self-luminous display panel that is disposed independent from the display panel located at the light transmission region AA. The touch display device 300 may adjust the button openings 112A to display different colors through pixels of the self-luminous display panel that display different colors.

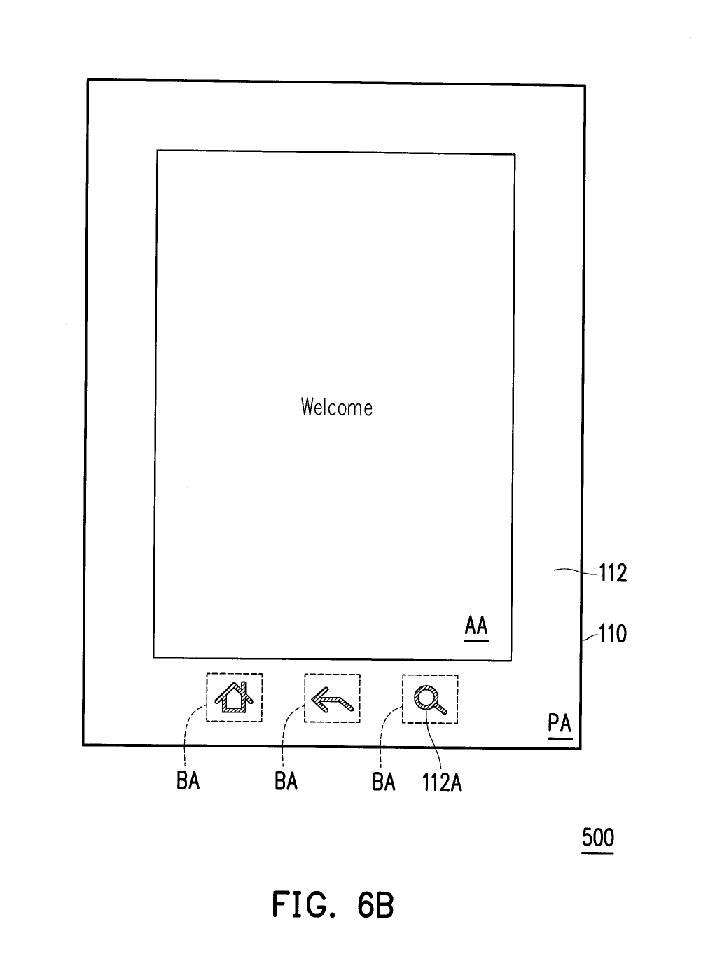

Referring to FIG. 1 and FIG. 5 at the same time, a touch display device 400 includes a touch panel 110 and a light providing unit 330. In this embodiment, the light providing unit 330 includes at least two light emitting elements 332 and 334 disposed at a side of the touch panel 110 to correspond to the same button opening 112A, as shown in the figure. Each of the button openings 112A includes a main light emitting element 332 and an auxiliary light emitting element 334 for emitting lights of different colors. Accordingly, the main light emitting element 332 and the auxiliary light emitting element 334 are turned on or off for the button openings 112A to display different colors, thereby achieving various visual effects.

To be more specific, only one or both of the main light emitting element 332 and the auxiliary light emitting element 334 that correspond to the same button opening 112A may be selectively turned on. Hence, when the main light emitting element 332 and the auxiliary light emitting element 334 are used to emit lights of different colors, the corresponding button opening 112A is capable of displaying at least three different colors.

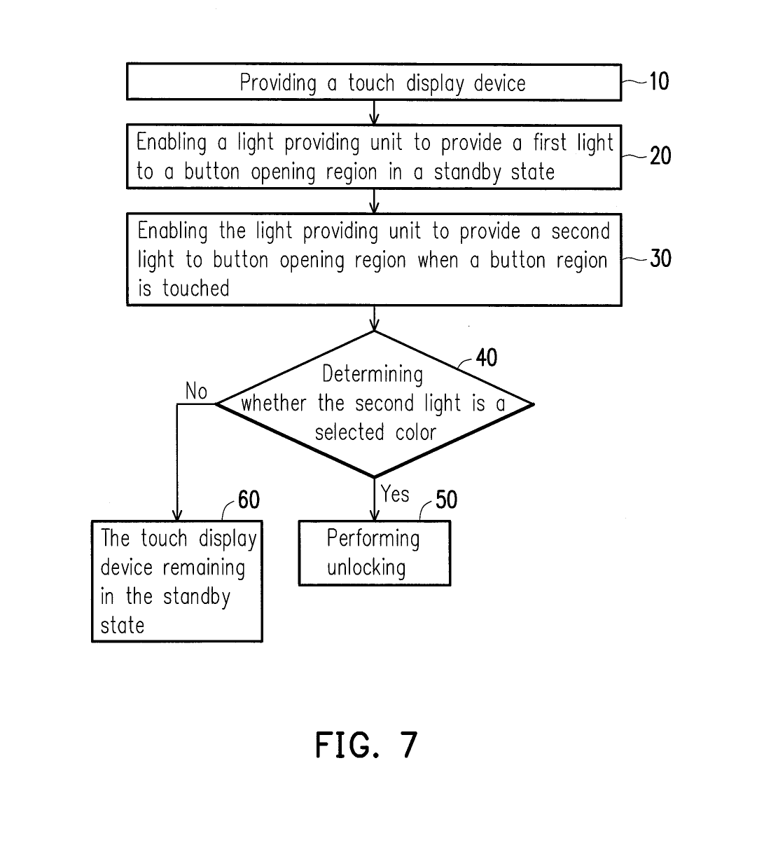

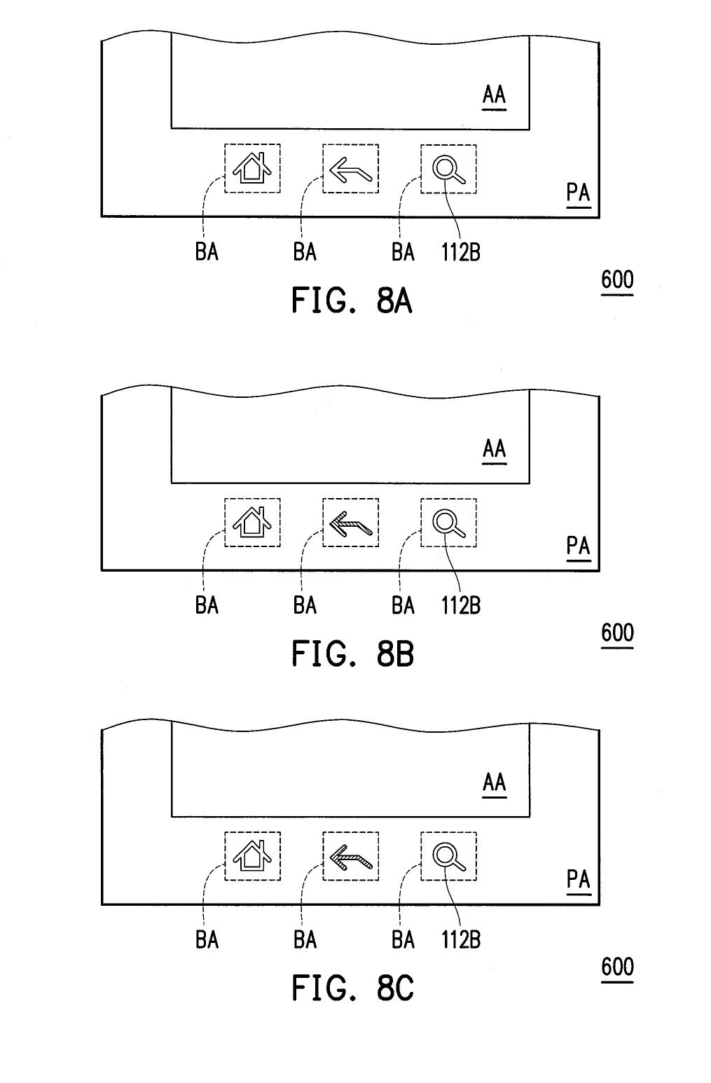

Referring to FIG. 6A and FIG. 7 at the same time, in Step 10, a touch display device 500 is provided. The touch display device 500 provided in this embodiment is for example one of the touch display devices 100-400 in the above embodiments. In other words, by means of the light provided by the light providing unit (not shown), the button opening 112A in the button touch region BA displays different colors when the touch display device is in different states.

In Step 20, when the touch display device 100 is in a locked state, the light providing unit (not shown) provides a first light to the button opening 112A, and the first light is for example the white light mentioned in the above embodiments. At the same time, as shown in FIG. 6A, the button opening 112A in the button touch region BA displays a first color, wherein the blank button opening 112A of FIG. 6A represents the first color. And, the light transmission region AA may display words, such as locked or please unlock. It is noted that the scope of the invention is not limited to the above. That is, when the touch display device 500 is in the locked state, the light transmission region AA may selectively display no word or image. It is worth mentioning that “the touch display device 500 is in the locked state” described in this embodiment means that the light transmission region AA does not perform display responsive to the user's operation.

Next, in Step 30, when the button touch region BA is touched, the light providing unit (not shown, referring to the description of the above embodiment) provides a second light, e.g. the colored light mentioned above, to the button touch region BA according to the touch action. At the same time, as shown in FIG. 6B, if all the button touch regions BA are touched, the button openings 112A in the button touch regions BA display a second color different from the first color, wherein the hatched button openings 112A of FIG. 6B represent the second color.

Then, in Step 40, the touch display device 500 may, for example, determine whether the second light has a selected color. If so, an unlocking action of Step 50 is performed, as shown in FIG. 6B, for displaying a command outputted via the touch panel 110 in the light transmission region AA of the touch display device 500. If not, Step 60 is performed to keep the touch display device 500 in the locked state of FIG. 6A. In other words, when the user touches the button touch region BA for the button opening 112A of the button touch region BA to display the selected color, the touch display device 500 performs the unlocking action, such that the display panel (not shown) displays image information according to the user's operation. Accordingly, the button opening 112A in the button touch region BA of the touch display device 500 not only serves as a hot key but also serves as an unlocking key.

In this embodiment, the touch display device 500 includes three button openings 112A to define three different button touch regions BA. In the case that the light providing unit (not shown) provides lights of two different colors to each button touch region BA, one of the colors may be defined as the selected color and the other color may be defined as a standby color. If the unlocking function is set to be performed when the three button openings 112A all display the selected color, the user needs to touch the three button touch regions BA so as to perform the unlocking function. If the unlocking function is set to be performed when one of the button openings 112A displays the selected color, the user needs to touch the selected button touch region BA so as to perform the unlocking function. It should be understood that the unlocking function may also be set to be performed when two of the button openings 112A display the selected color, and in that case, the user needs to touch the selected two button touch regions BA so as to perform the unlocking function.

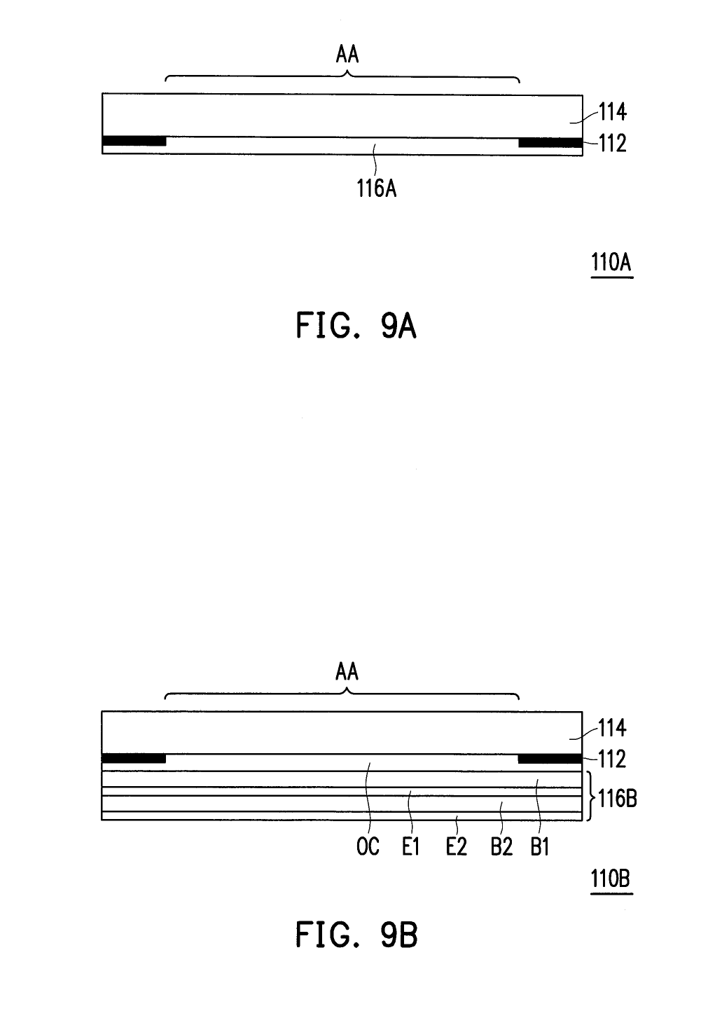

Furthermore, referring to FIG. 8A, in the case that the light providing unit (not shown) of a touch display device 600 selectively provides lights of three or more different colors to each button touch region BA, one of the colors may be defined as the selected color and the others of the colors may be defined as the standby color. In a standby state, as shown in FIG. 8A, the button opening 112A of each button touch region BA displays the first light of the first color, for example, and the first color is for example the standby color, wherein the blank button opening 112A of FIG. 8A represents the standby state.

In this embodiment, after each of the button touch regions BA is touched, the light providing unit (not shown) provides the second light, for example, for the button opening 112A to display another color different from the standby color. Moreover, the color of the second light may vary according to the number of times of the user's touch. Hence, as shown in FIG. 8B and FIG. 8C, the button touch region BA in the middle displays the first color when the user touches for the first time and displays the second color when the user touches for the second time. Herein, the button opening 112A with hatching of backslashes represents the state of displaying the first color, and the button opening 112A with hatching of slashes represents the state of displaying the second color.

If the second color is set as the selected color of the unlocking function, and the unlocking function is performed only when the button opening 112B in the middle displays the selected color, as shown in FIG. 8A to FIG. 8C, the user needs to touch the button touch region BA twice in order to perform the unlocking function. It should be understood that the unlocking function may also be performed when the three button openings 112A all display the selected color, and in that case, the user needs to touch all the button touch regions BA twice so as to perform the unlocking function. If the unlocking function is set to be performed when two of the button openings 112A display the selected color, the user needs to touch the corresponding two button touch regions BA twice so as to perform the unlocking function.

In addition, different button touch regions BA may be set to have different selected colors. For example, if the selected color of the button touch region BA on the left is the first color, the selected color of the button touch region BA in the middle may be the second color. In that case, the user needs to touch the button touch region BA on the left once and touch the button touch region BA in the middle twice, so as to perform the unlocking function.

The selected color and the selected button touch region BA in the above embodiments may be set by the user that operates the touch display devices 500 and 600. Thus, this embodiment utilizes the light providing unit to provide lights of various colors to the button opening 112A, which allows the user to unlock the touch display device by his/her own setting, so as to protect the user's data.

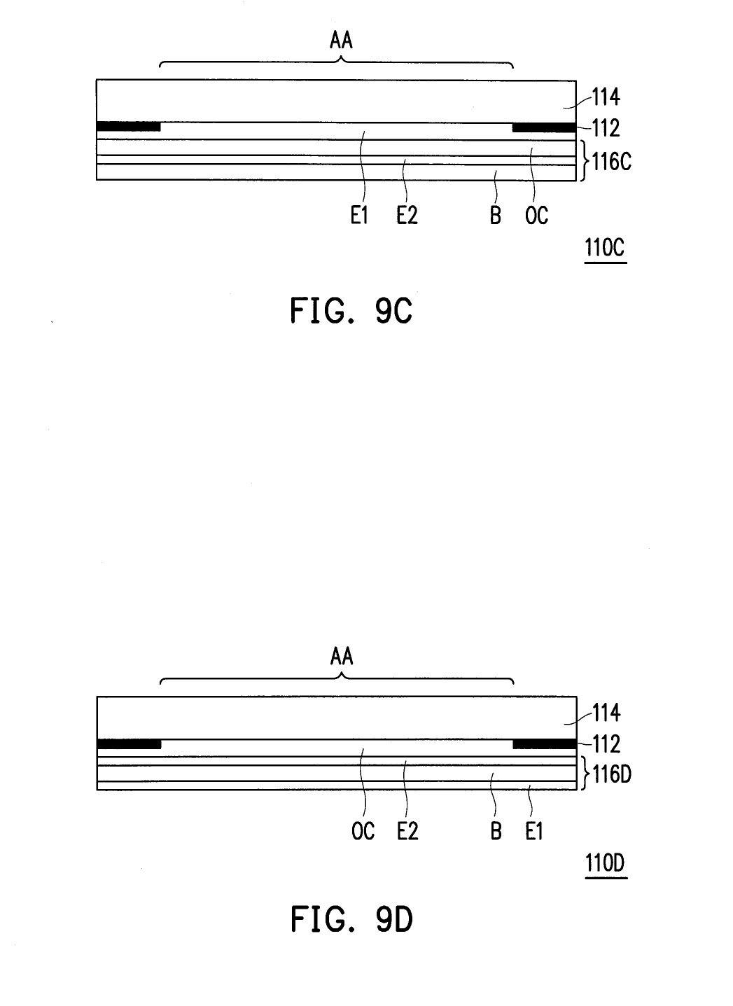

Please refer to FIGS. 9A to 9D, which illustrate various ways of embodying the touch panel 110 disclosed in the above embodiments; nevertheless, it is noted that the invention is not limited thereto. In FIG. 9A, the touch panel 110 further includes a touch sensing element 116A disposed on the cover plate 114, in addition to the decoration layer 112 and the cover plate 114. Here, the touch sensing element 116A may be formed of a single-layer conductive electrode or formed of sensing electrodes, which are arranged to intersect each other in different directions. For instance, the touch sensing element 116A includes a plurality of first sensing series extending in a first direction and a plurality of second sensing series extending in a second direction. The first sensing series are insulated from the second sensing series. The first direction and the second direction intersect each other. Moreover, the first sensing series and the second sensing series are respectively formed by arranging a plurality of electrodes. The electrodes of each of the first sensing series are connected by a connecting line and the electrodes of each of the second sensing series are connected by another connecting line. The connecting lines of the first sensing series and the second sensing series, which intersect each other, are insulated from each other. In FIG. 9B, the touch panel 110 further includes a touch sensing element 116B, in addition to the decoration layer 112 and the cover plate 114. The touch sensing element 116B includes a first substrate B1, a second substrate B2, a plurality of first sensing electrodes E1 extending in the first direction, and a plurality of second sensing electrodes E2 extending in the second direction. The first sensing electrodes E1 are disposed on the first substrate B1, and the second sensing electrodes E2 are disposed on the second substrate B2. The first sensing electrodes E1 may be disposed on a side of the first substrate B1, and the second sensing electrodes E2 may be disposed on a side of the second substrate B2, as shown in the figure. The first and the second sensing electrodes E1 and E2 may be respectively located on the sides of the first substrate B1 and the second substrate B2, which face toward the cover plate 114 or away from the cover plate 114 (not shown in the figure), and the first substrate B1 is adhered onto the cover plate 114 via an optical adhesive OCA.

In FIG. 9C, the touch panel 110 further includes a touch sensing element 116C, in addition to the decoration layer 112 and the cover plate 114. The touch sensing element 116C includes a plurality of first sensing electrodes E1, an insulating layer, a plurality of second sensing electrodes E2, and a substrate B. The first sensing electrodes E1 and the second sensing electrodes E2 are respectively formed of electrode patterns in different extending directions, for example. Herein, the first sensing electrodes E1 may be disposed on the cover plate 114 and the second sensing electrodes E2 are disposed on the substrate B. The insulating layer is an optical adhesive OCA, for example, and the substrate B is adhered onto the cover plate 114 via the optical adhesive OCA. The second sensing electrodes E2 of the invention are not necessarily disposed on the cover plate 114 and may be directly disposed on the insulating layer (not shown in the figure). That is, the first sensing electrodes E1, the insulating layer, and the second sensing electrodes E2 are sequentially disposed on the substrate, and then the substrate is adhered to the cover plate via another optical adhesive OCA.

In FIG. 9D, the touch panel 110 further includes a touch sensing element 116D, in addition to the decoration layer 112 and the cover plate 114. The touch sensing element 116D includes a plurality of first sensing electrodes E1, a plurality of second sensing electrodes E2, and a substrate B. The first sensing electrodes E1 and the second sensing electrodes E2 are respectively formed of electrode patterns in different extending directions, for example. Herein, the first sensing electrodes E1 and the second sensing electrodes E2 are disposed on different sides of the substrate B. In addition, the substrate B is adhered onto the cover plate 114 via an optical adhesive OCA.

In conclusion of the above, according to the invention, a light providing unit is disposed for providing lights of different colors to the button opening in the periphery region. When the user touches the button touch region, the color of the button opening varies, so as to provide various visual effects. Moreover, the color variation of the button opening is also used as the unlocking command.

It will be apparent to those skilled in the art that various modifications and variations can be made to the disclosed embodiments without departing from the scope or spirit of the invention. In view of the foregoing, it is intended that the invention covers modifications and variations of this disclosure provided that they fall within the scope of the following claims and their equivalents.

What is claimed is:

1. A touch display device, comprising:
a touch panel comprising a cover plate, a touch sensing element, and a decoration layer, wherein the cover plate comprises a light transmission region and a periphery region at least partially surrounding the light transmission region, the touch sensing element is at least located in the light transmission region, and the decoration layer is disposed in the periphery region and comprises at least one button opening located in the periphery region to define at least one button touch region; and
a light providing unit at least disposed at a side of the touch panel, which faces toward the button opening, to provide at least one of a first light and a second light to the button opening, and colors of the first light and the second light being different from each other.

2. The touch display device according to claim 1, wherein the periphery region substantially completely surrounds the light transmission region.

3. The touch display device according to claim 1, wherein the light providing unit comprises a first light emitting element, a second light emitting element, a light guide plate, and an adhesive layer, wherein the adhesive layer is adhered to the decoration layer, the first light emitting element is located at a lateral side of the light guide plate, and the second light emitting element is located under the light guide plate and emits light to the button opening.

4. The touch display device according to claim 3, wherein the adhesive layer comprises a hole corresponding to each button opening, and the second light emitting element corresponds to the hole.

5. The touch display device according to claim 3, wherein the light providing unit further comprises a reflective plate disposed under the second light emitting element.

6. The touch display device according to claim 1, wherein the light providing unit comprises a color light valve, a light guide plate, a light emitting element, and a reflective plate, wherein the color light valve, the light guide plate, and the reflective plate are sequentially arranged downward under the touch panel, and the light emitting element is located at a side of the light guide plate.

7. The touch display device according to claim 1, wherein the light providing unit is a self-luminous display panel.

8. The touch display device according to claim 1, wherein the light providing unit comprises at least two light emitting elements disposed at a side of the touch panel corresponding to each button opening.

9. The touch display device according to claim 3, wherein each of the first light emitting element and the second light emitting element is a light emitting diode element.

10. The touch display device according to claim 8, wherein the light emitting elements are a light emitting diode element respectively.

11. The touch display device according to claim 1, wherein the number of the at least one button opening is two or more.

12. The touch display device according to claim 11, wherein the button openings have different patterns.

13. The touch display device according to claim 1, wherein the touch sensing element comprises a plurality of first sensing series extending in a first direction and a plurality of second sensing series extending in a second direction, wherein the first sensing series and the second sensing series are respectively formed by arranging a plurality of electrodes, the electrodes of each of the first sensing series are connected by a connecting line and the electrodes of each of the second sensing series are connected by another connecting line, and the connecting lines of the first sensing series and the second sensing series, which intersect each other, are insulated from each other.

14. The touch display device according to claim 1, wherein the touch sensing element is formed of a single-layer conductive electrode.

15. The touch display device according to claim 1, wherein the touch sensing element is formed of sensing electrodes arranged to intersect each other in different directions and at least comprises a plurality of first sensing electrodes extending in the first direction and a plurality of second sensing electrodes extending in the second direction.

16. The touch display device according to claim 15, wherein the touch sensing element further comprises a substrate, the first sensing electrodes and the second sensing electrodes of the touch sensing element are disposed on different sides of the substrate, and the substrate is adhered to the cover plate via an optical adhesive.

17. The touch display device according to claim 15, wherein the touch sensing element further comprises a substrate, wherein the first sensing electrodes are disposed on the substrate and the second sensing electrodes are disposed on the cover plate, and the substrate is adhered to the cover plate via an optical adhesive.

18. The touch display device according to claim 15, wherein the touch sensing element further comprises a substrate, wherein the first sensing electrodes, an insulating layer, and the second sensing electrodes are sequentially disposed on the substrate, and the substrate is adhered to the cover plate via an optical adhesive.

19. The touch display device according to claim 15, wherein the touch sensing element further comprises a first substrate and a second substrate, wherein the first sensing electrodes are disposed on a side of the first substrate and the second sensing electrodes are disposed on a side of the second substrate, and the first substrate is adhered to the cover plate via an optical adhesive.

20. The operation method according to claim 1, wherein the at least one button opening is filled with an light transmission layer.

21. An operation method of a touch display device, comprising:
providing a touch display device as claimed in claim 1;
enabling the light providing unit to provide the first light to the button opening when the touch display device is in a locked state;
enabling the light providing unit to provide the second light to the button opening when the button touch region is touched; and
determining whether the second light is a selected color, and performing unlocking if the second light is the selected color; or keeping the touch display device in the locked state if the second light is not the selected color.

22. The operation method according to claim 21, wherein the second light has different colors according to the number of times that the button touch region is touched, and one of the colors is the selected color.
